(19) United States
(12) Patent Application Publication
(10) Pub. No.: US 2016/0040809 A1
(43) Pub. Date: Feb. 11, 2016

(54) EXHAUST SYSTEM CONNECTION ASSEMBLY

(71) Applicant: M&G DuraVent, Inc., Vacaville, CA (US)

(72) Inventors: Matthew L. Bertler, Vacaville, CA (US); Ryan L. Devine, Richmond, CA (US); Paul Levallois, Gold River, CA (US)

(21) Appl. No.: 14/453,549

(22) Filed: Aug. 6, 2014

(51) Int. Cl. F16L 21/08; F16L 37/12; F16L 21/00

(52) U.S. Cl. CPC F16L 21/08; F16L 21/002; F16L 37/1205

(57) ABSTRACT

A securing assembly with a securing structural element adapted to couple a first exhaust system part to a second exhaust system part. The assembly includes a element having a first surface attached to an exterior surface of the first exhaust system part, the element engaging at least a portion of the exhaust system part. The element may be cylindrical or rectangular. A bottom surface of the element includes a plurality of energy directors extending from the bottom surface to a height above the bottom surface. The directors allow sonic welding of the element to an arcuate side of the exhaust system part.

### BACKGROUND

It is generally known to connect end sections of fluid line parts, such as, for example, of pipes, to one another by means of screw, flange, clamping or sleeve connections in order to form a fluid line or pipeline. In the case of clamping connections, those end sections of the pipes or fluid line parts which are to be connected are completely surrounded by a clamping body. The clamping body is then drawn together by means of one or more screw connections and thereby wedges in those end sections of the pipes which are to be connected, wherein the region to be clamped together comprises virtually 360° and the surface pressure between the pipe and clamping body is built up uniformly. In this case, the permissible tightening torque of the screws has to be noted in order to obtain the required frictional connection between the clamping body and the pipes such that the tightness of the connection is ensured.

### SUMMARY

he technology comprises a securing assembly with a securing structural element adapted to couple a first exhaust system part to a second exhaust system part. The assembly includes a rectangular or circular element (button) having a first surface attached to an exterior surface of the first exhaust system part, the button engaging at least a portion of the structural element. The element may comprise a rectangular element having a first side, second side, third side and fourth side, and a top surface and a bottom surface. The first and second sides define a length greater than a width defined by the third and fourth sides. A bottom surface includes a plurality of raised energy directors extending from the bottom surface to a height above the bottom surface. The energy directors allow sonic welding of the rectangular element where the element's length is transverse to an arcuate side of the exhaust system part.

### BRIEF DESCRIPTION OF THE DRAWINGS

FIG. 1 is a perspective view of one embodiment of an exhaust system connection assembly.

FIG. 2 is a plan view of the connection assembly of FIG. 1.

FIG. 3 is a rotated plan view of the connection assembly of FIG. 2 rotated 90 degrees.

FIG. 4 is an enlarged, cross-sectional view of the connection assembly of FIGS. 1-3.

FIG. 5 is a partial perspective view of a second connection assembly in accordance with the technology.

FIG. 6 is a rotated plan view of the second connection assembly with the top pipe section rotated with respect to the bottom pipe section.

FIG. 7A is a perspective view of a button structure used in the aforementioned connection assemblies.

FIG. 7B is a top view of the button structure.

FIG. 7C is an end view of the buttons structure.

FIG. 7D is a bottom view of the button structure.

FIG. 8 is a top view of an assembly system capable of installing the button structure on an exhaust system part.

FIGS. 9-13 are side view of the assembly system of FIG. 8 in various states of movement.

FIGS. 14A and 14B are enlarged views of a button resting on an exhaust system part.

FIG. 15 is an enlarged view of a button secured to an exhaust system part.

FIG. 16 is a perspective view of an alternative embodiment of the connection assembly of the present technology.

FIG. 17A is a perspective view of the alternative button structure.

FIG. 17B is a top view of the alternative button structure.

FIG. 17C is a is a side view of the alternative button structure.

FIG. 17D is a bottom view of the alternative button structure.

### DETAILED DESCRIPTION

Technology is presented enabling an exhaust system connection for any of a number of fluid line parts or shaped parts/shaped pieces, such as, for example, pipes, pipe bends, T pieces, Y pieces, sleeves, U pipes, pipe branches, reducing means or reductions, pipe sockets and the like are included. The technology may include a securing assembly with a securing structural element adapted to couple a first exhaust system part to a second exhaust system part and a rectangular element having a first surface attached to an exterior surface of the first exhaust system part, the button engaging at least a portion of the structural element. The element may comprise a rectangular element having a first side, second side, third side and fourth side, and a top surface and a bottom surface. The first and second sides define a length greater than a width defined by the third and fourth sides. A bottom surface includes a plurality of raised energy directors extending from the bottom surface to a height above the bottom surface. The energy directors allow sonic welding of the rectangular or circular element where the element's length is tangent to an arcuate surface of the exhaust system part.

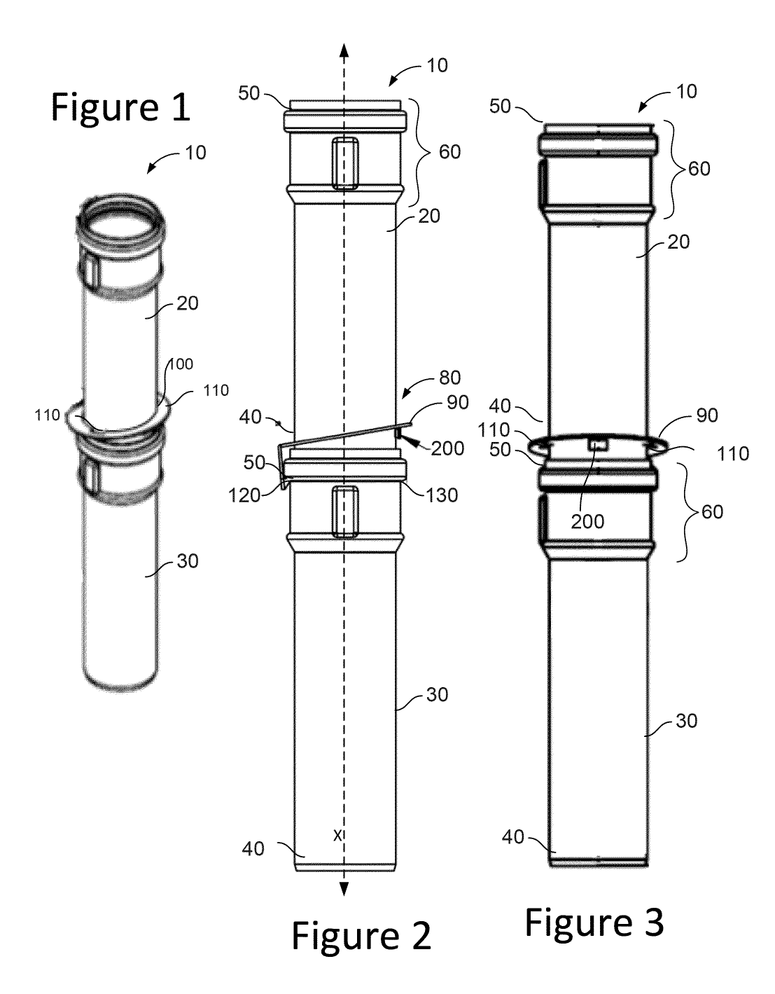

FIGS. 1-4 show a first exhaust system connection assembly 10. The system connection assembly 10 comprises a first pipe section 20 and a second pipe section 30 which, may be both of circular-cylindrical design and are composed of plastic. An example of a suitable material for the pipes is polypropylene.

The two pipe sections 20 and 30 are shaped at the respective end sections 40 and 50 to allow connection to each other in the manner of a plug-in sleeve connection. During the connection thereof, the end section 40 of the first pipe 20 is plugged into the end section 50 of the second pipe 30. Each pipe section 20, 30 may be similarly or identically constructed. The pipe connection described herein may alternatively be a connection of a pipe to, for example, a T piece or different parts or shaped pieces. In the exemplary embodiment, the inside diameter of the respective sleeve-shaped end sections 60 of the end 50 of pipes 20 and 30 is dimensioned to be slightly larger than the outside diameter of the pipes 20 and 30 at end 40. The respective end section 50 includes a transition region 60 having an interior ledge against which, in the assembled arrangement of the pipe connection 10, the end surface of the first end section 40 of the first pipe 20 bears. The second end section 50 of the second pipe 30 has a step-shaped expansion in the form of the transition region 60 in order to receive the first end section 40 of the first pipe 20.

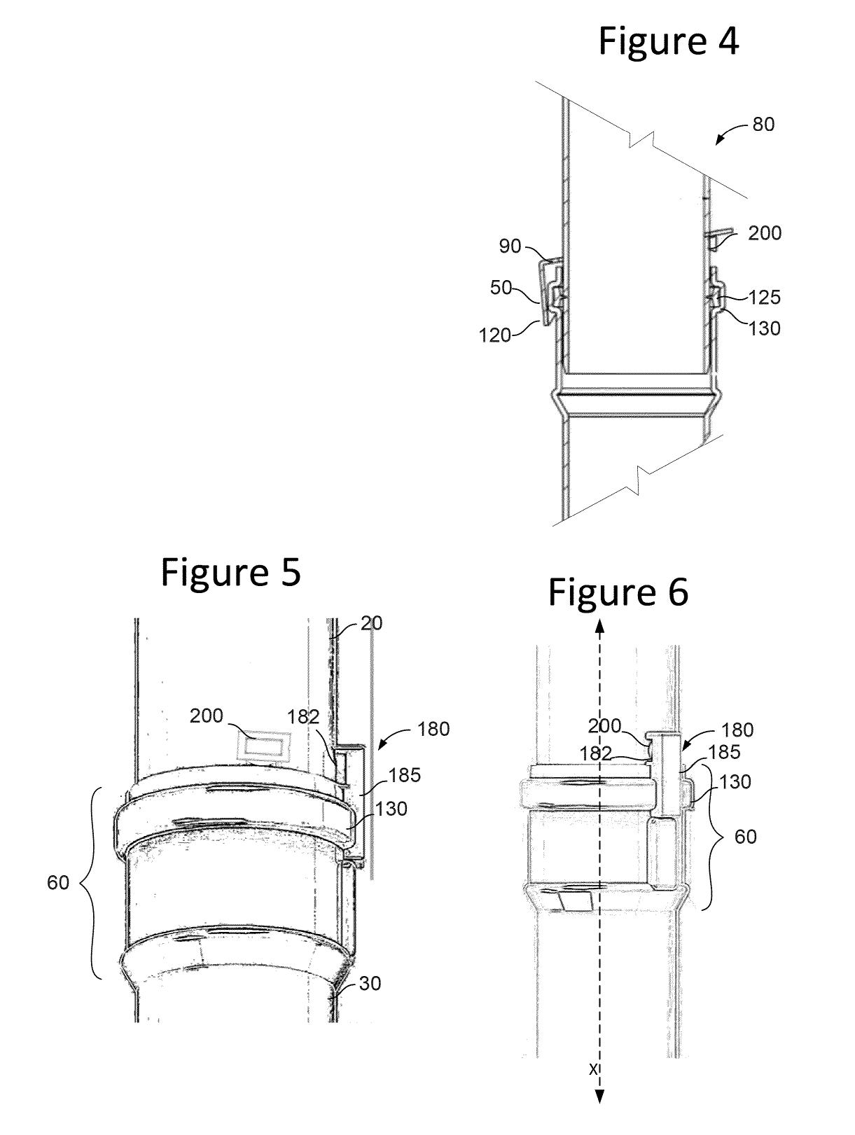

The sealing between the first pipe 20 and the second pipe 30 may be performed by a sealing element such as a gasket 125 (FIG. 4). The sealing element used may be an O-ring, a lip seal, a T-shaped profile seal or the like which are inserted in the groove or annular bead which runs on the inside and is formed in the transition region 60. In one embodiment, the gasket 125 is contained in a spacer ring 130.

In order to ensure an axial connection of the first and second pipes 20, 30 in a manner strong in tension, a securing device assembly 80 may be provided. Two different securing device assemblies 80 and 180 (FIGS. 5-6) are illustrated herein. Each device assembly includes a button 200 and a securing structural element (90, 185).

A first securing device assembly 80 illustrated in FIGS. 1-4. In this first embodiment, the securing device assembly 80 has a securing structural element 90 which is of annular or ring-like design and has a passage opening 100 with one or more notches 110 formed therein. Opening 100 is matched to the outside diameter of the pipes 20 and 30. The securing structural element 90 surrounds the passage opening 100 and in order to install the securing device 80, the second pipe 30 can inserted into the passage opening 100 with a button 200 passing through one of notches 110 so that a portion of the securing structural element 90 rests on button 200, while a retaining element 120 of hook-shaped design extends in the axial direction (axis X) of the pipes 20 and 30 and which is adjoined by a section coupled to a spacer ring 130 of pipe end 50. In this embodiment, the securing structural element 90 is composed of a metallic material.

FIGS. 5-6 show a second embodiment of a securing assembly 180. The second embodiment of the securing assembly 180 includes a retainer block 185 which can snap fit to spacer ring 130 of pipe section 20/30. Retainer block 185 includes a recess 182 which engages a button 200 which is secured to pipe end 40 of a pipe section 20/30. As illustrated in FIGS. 5 and 6, button 200 is secured to pipe section 20 and the retainer block 185 is secured to pipe section 30. From the position shown in FIG. 5, pipe 30 is rotated with respect to pipe section 20 so that button 200 engages a notch 182 in retaining block 185 to secure the pipes together.

As discussed herein, an integral component of the securing assemblies 80 and 180 is button 200 and the technology herein provides a unique button structure and assembly method suitable for use with the various securing assemblies disclosed herein.

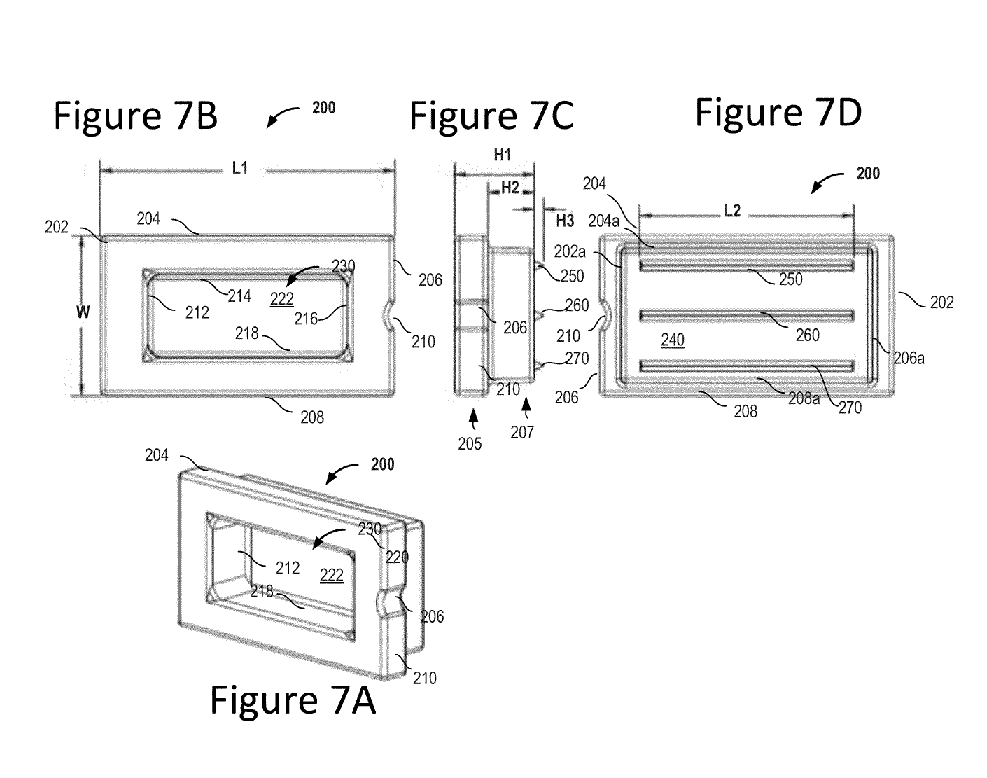

FIG. 7 illustrates one configuration of a button 200 in accordance with the present technology. The button 200, in one embodiment, comprises a generally rectangular element 200 having features enabling rapid manufacturing using automated positioning mechanisms and ultrasonic welding techniques. Button 200 includes an upper section 205 and lower, smaller section 207. Upper section 205 includes four sidewalls comprising a first side 202, second side 204, third side 206 and fourth side 208. The upper block is formed contiguous to lower block having sides 202a, 204a, 206a, and 208a. The upper block has a length L1 of approximately 0.44 inch (and a maximum of about one (1) inch, and a width W of approximately 0.24 inch. A top surface 220 has a recessed region 230 formed by sidewalls 212, 214, 216, and 218, and base surface 222.

Bottom surface 240 includes three raised energy directors 250, 260, generally formed as ridges having a generally triangular cross-section as illustrated in FIG. 7C which have a length which is slightly shorter than the length of bottom surface 240. Length L2 of each of the ridges is approximately 0.32 inch. Each ridge 250, 260, 270 has a height H3 of about 0.01 inch above surface 240 and may be in a range of 0.007 inch to 0.03 inch. Lower block 207 has a height H2 of about 0.7 inch and upper block 205 and lower block 207 have a combined height H1 of about 0.12 inch. It should be understood that the above dimensions are exemplary and may be enlarged or reduced based on the application for which the button and securing assembly are constructed. The aforementioned dimensions are suitable for use with pipe sections having a two inch to 20 inch (60 mm-500 mm) diameter.

As explained further below, energy directors 250, 260, 270 allow the use of the ultrasonic welding to attach the button 200 to the arcuate surface of pipe sections 20, 30. The dimensions of the button 200 are chosen to facilitate any of the aforementioned assembly system as well as the use of the manufacturing process described herein. As such, the raised energy directors for a button may comprise ridges, rails, or other structures which act as sacrificial bonding elements.

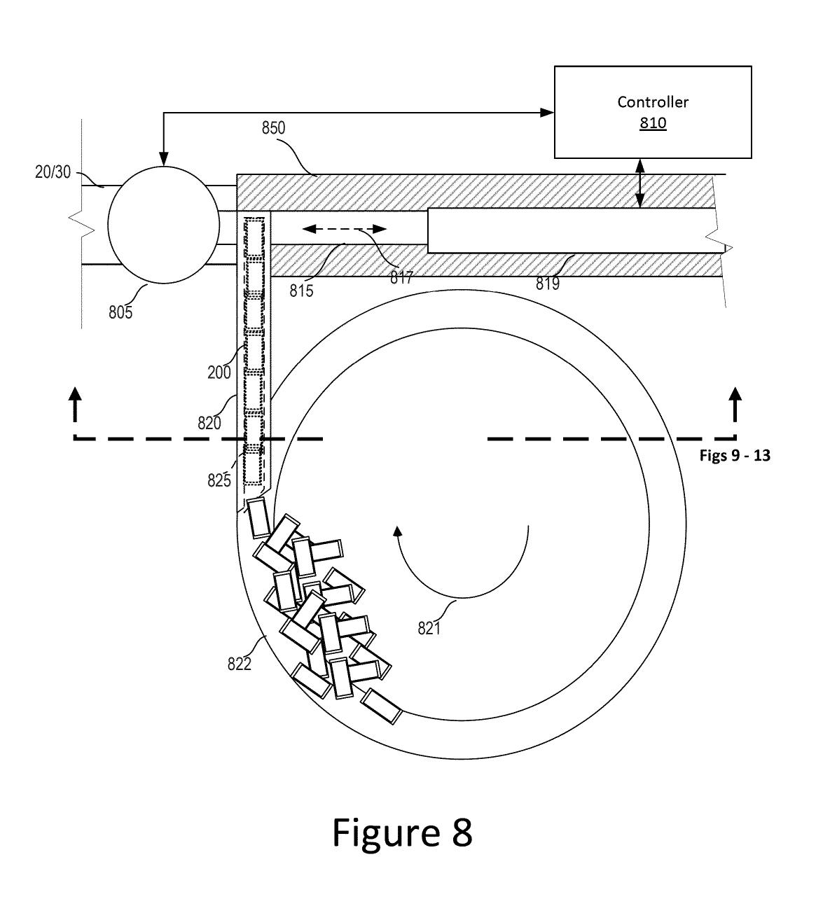

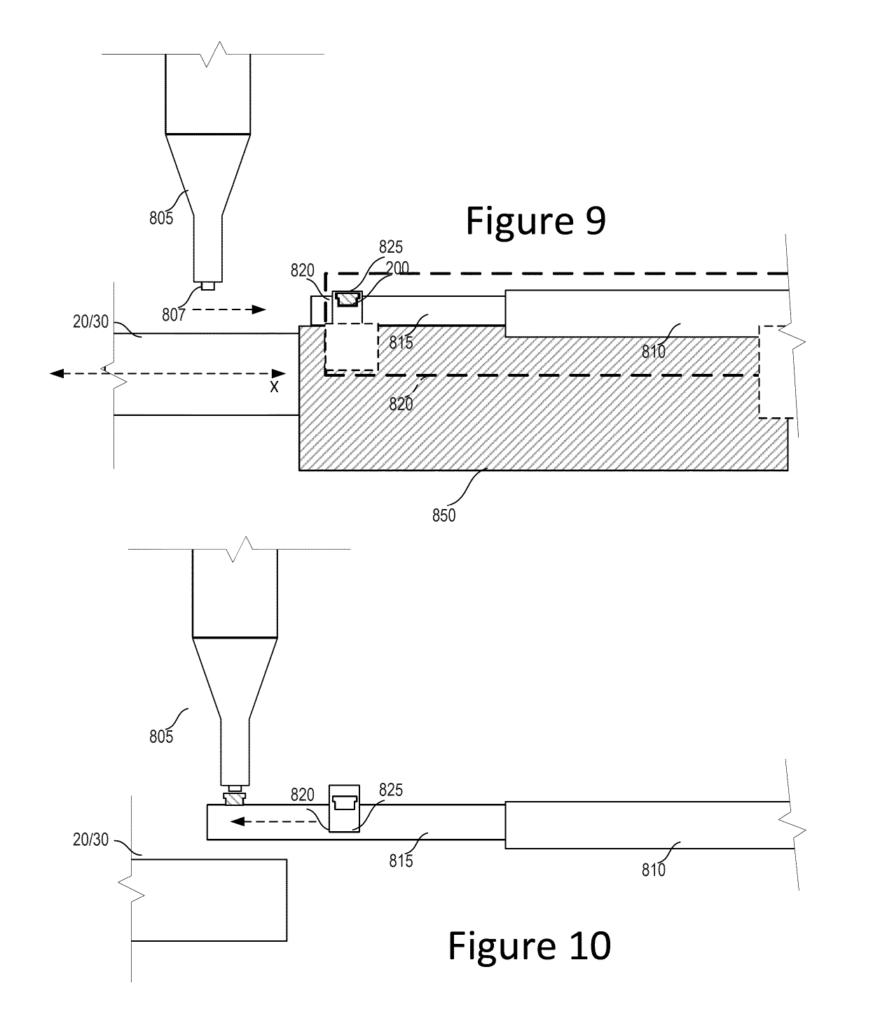

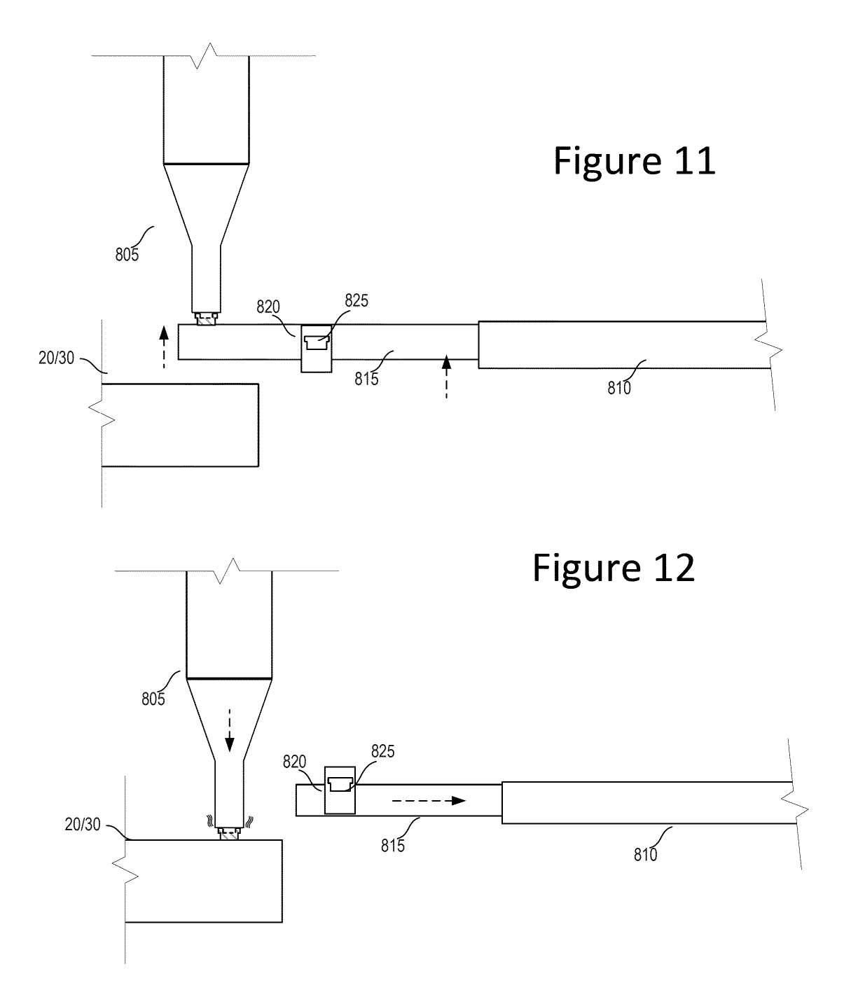

FIG. 8 illustrates a top view of an assembly system suitable for coupling buttons to pipe sections or other exhaust pieces in accordance with the technology herein. FIG. 8 illustrates a top view and FIGS. 9-13 various side views of the assembly system. A part feeding bin 822 may be loaded with a plurality of button parts and conveys the buttons in the direction of arrow 821 to a loading system to transfer buttons for subsequent adhesion. The loading system includes a feed structure 820 and channel therein 825, positioning arm 815 and pneumatic cylinder 819. As the bin feeds the direction of arrow 821, parts are fed through a feed channel 825 and are retrieved by positioning arm 815. The positioning arm delivers a button to the ultrasonic welder horn by extending and retracting along axis 817 under the power of a pneumatic cylinder 819. Buttons 200 are continually fed through channel 825 into a position where positioning arm in a fully retracted position may retrieve one button per pass.

A controller 810 is coupled to the pneumatic cylinder 819, and an ultrasonic weld horn 805. The controller may actuate the pneumatic cylinder under the direction of a human installer, or using a sensor to indicate the presence of a part against alignment block 850. In operation, an installer will align a part (pipe section 20, 30) against the alignment block 850, the positioning arm 815 will transfer a button to a weld horn, and the ultrasonic welding assembly 805 will descend and attach the button to the part. As parts are fed into the feed channel 825, they force individual buttons toward the positioning arm 815.

FIGS. 9 to 13 illustrate a side view of the components illustrated in FIG. 8 and a sequence of operations comprising a method for installing a button on an exhaust system component. For clarity, the part feed bin 822 is illustrated only in phantom in FIG. 9.

In a unique aspect of the technology, the structure of the button 200, detailed above with respect to FIG. 7, and the configuration of the feed channel 825 ensures that the button can only enter the channel in an orientation suitable for installation on a pipe section 20, 30.

As illustrated in FIG. 9, the channel 825 has a cross-sectional shape slightly larger than and generally corresponding to the shape of the cross-section of button 200 as shown in FIG. 7C. This “T” shape ensures that the buttons 200 can only enter the channel 825 in a direction suitable for installation on a part. In this embodiment, the direction of orientation of a button 200 is that length L1 is perpendicular to a central axis X of the pipe section 20, 30, and bottom surface 240 including raised energy directors 250, 260, 270 engages the arcuate surface of a pipe section. As the part feeder 820 conveys, a plurality of buttons will enter channel 825 and push each other toward the positioning arm 815. However, buttons will only enter channel 825 in a proper horizontal and vertical orientation because of the structure of the cross section.

A button at the end of channel 825 will be retrieved by the positioning arm 815. FIG. 9 illustrates the positioning arm 815 retracting to receive a button 200 from the feed channel 825. The button may or may not be secured to arm 815 by suction or by a mechanical clamping of the button by the arm 815. This operation may occur as a result of a manual control by a human system operator or in response to a sensor indicating the placement of a part in an installation position against an alignment block 850. The positioning of the part against alignment block and the operation of the controller may also be entirely automated. In a further embodiment, automated positioning of the part in relation to the welder 805 may be performed without the alignment block 850.

Once the positioning arm 815 retrieves a button 200, the arm 815 extends as in FIG. 10 to position the button over a pipe section 20, 30. In FIGS. 9 and 10, the sonic welder 805 is in a retracted.

Once over the part as in FIG. 10, arm 815 moves in an upward direction, transferring the button to the weld horn 805, the button held by means of suction and oriented via engagement with horn tip and button recess 230.

Next, as illustrated in FIG. 12, the positioning arm will retract, while sonic welder 805 will descend and presses the button 200 on exterior of the pipe section 20, 30. Recess 230 allows the similarly shaped horn tip from the sonic welder 805 to more directly transmit the ultrasonic vibrations to the raised energy director elements.

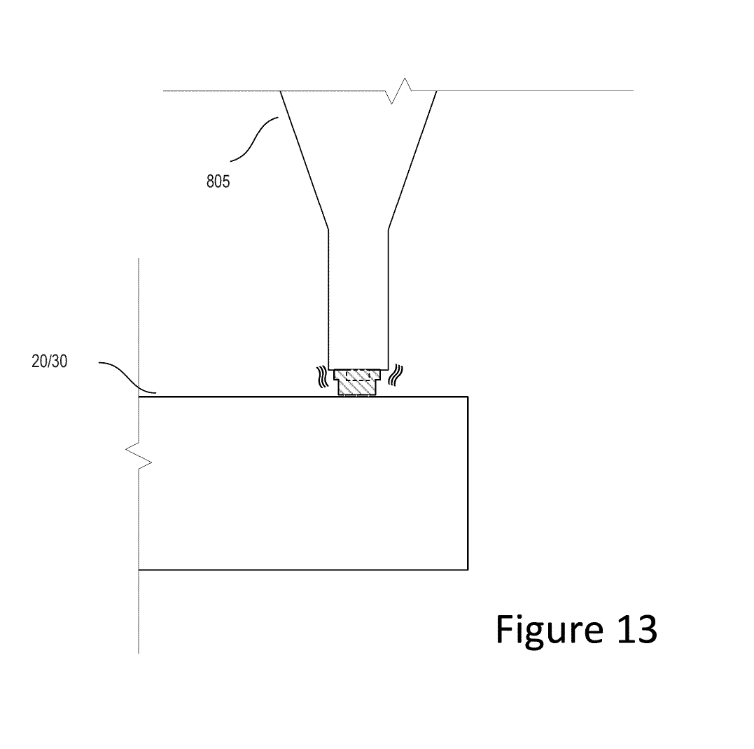

As illustrated in FIG. 13, which is an enlarged view of the end of the welder and button 200, the welder 805 descends and presses the button on the pipe section 20, 30 and applies ultrasonic vibrations sufficient to weld the button to the pipe section.

Connection of the button 200 to the pipe section is accomplished using the vibration of the sonic welder to cause the raised energy director 250, 260, 270 to melt together with the external pipe surface 20, 30.

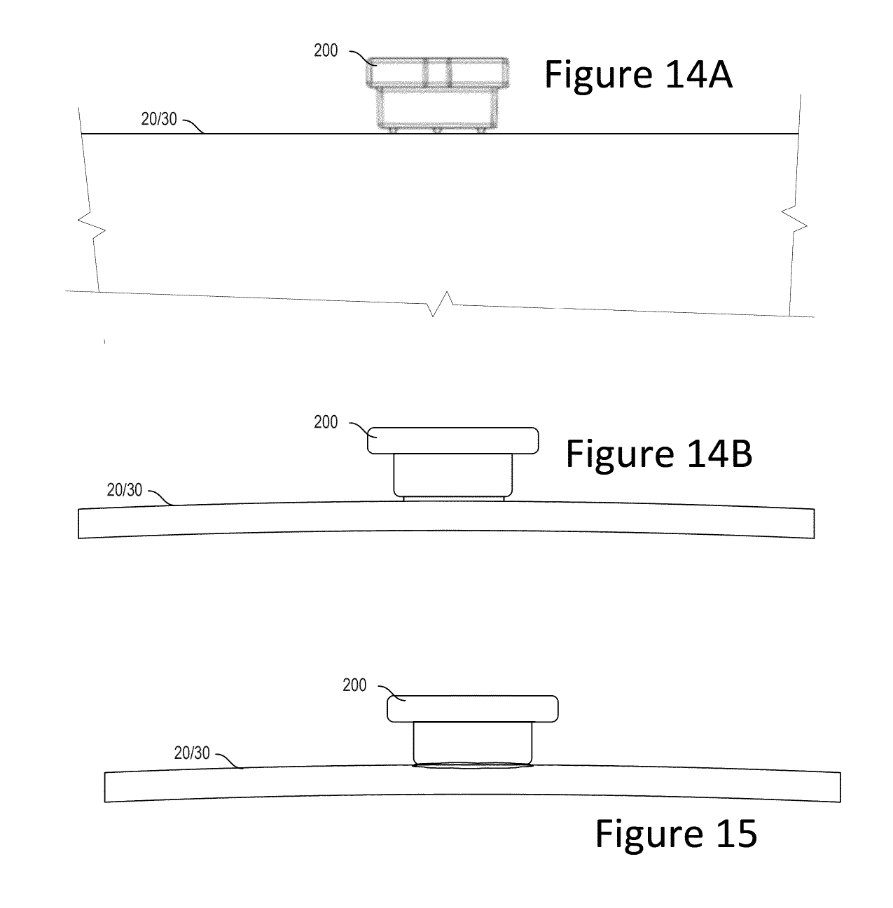

The placement, orientation, and subsequent welded structure of the button is illustrated in FIGS. 14A, 14B and 15. FIGS. 14A and 14B illustrate an enlarged view of the button 200 against the surface of the pipe section 20, 30. FIG. 14A is a view along the axis X of the pipe section, and FIG. 14B a view perpendicular to the axis X. As illustrated in FIG. 14A, the surface of the pipe section 20,30 is not flat but arcuate. The amount of arc depends on the diameter of the pipe section where the pipe section is cylindrical. However, it is noted that the length L1, L2 of the button 200 is perpendicular to the axis X and thus rests tangent to the arc of the surface of the pipe section.

The button 200 is held until the sonic welder 805 completes the welding process. FIG. 15 illustrates the resulting sonic weld, and melting of the raised energy directors 250, 260, 270. As shown in FIG. 15, the material of the energy directors acts to direct vibrational energy to the pipe surface, and both pipe surface and energy directors melt via friction. Upon completion of the cycle, button and pipe quickly cool, thereby bonding the button with sufficient strength for the various securing assemblies disclosed herein.

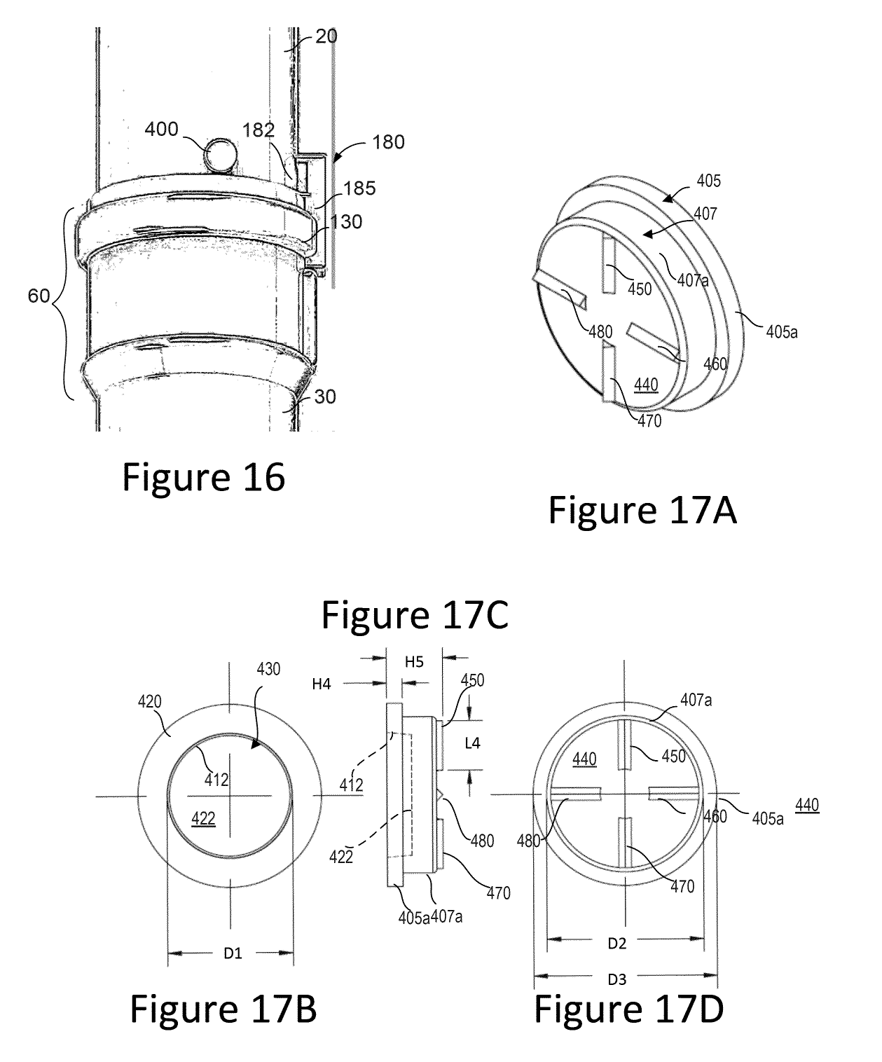

FIG. 16 represents a view similar to FIG. 5 showing an alternative button embodiment 400 which may be used with the securing structural element of FIGS. 1-4 or 5-6.

Button 400 is detailed in FIGS. 17A-17D. As illustrated therein, button 400 is a generally cylindrical button 400 having an upper section 405 and lower, smaller section 407. Upper section 405 includes a sidewall 405a and is formed contiguous to lower block 407 having a sidewall 407a. The upper block has a diameter D3 of approximately 0.44 inch (and a maximum diameter D3 of about one (1) inch, and lower block a diameter of 0.375 inch. A top surface 420 has a recessed region 430 formed by sidewall 412, and base surface 422. It should be noted that the welding horn will be provided in the cylindrical shape of the recess, and that while the recess is cylindrical as shown herein, the recess may have any number of various shapes.

Bottom surface 4420 includes four raised energy directors or ridges 450, 460, 470, 480 each having a generally triangular cross-section as illustrated at 480 in FIG. 17C. Each of ridges 450, 460, 470, 480 has a length L4 of approximately 0.12 inch. and a height of about 0.01 inch above surface 440 and may be in a range of 0.007 inch to 0.03 inch. Button 400 has a height H5 of about 0.13 inch with upper block 405 a height H4 of 0.04 inch. It should be understood that the above dimensions are exemplary and may be enlarged or reduced based on the application for which the button and securing assembly are constructed. The aforementioned dimensions are suitable for use with pipe sections having a two inch to 20 inch (60 mm-500 mm) diameter.

The foregoing detailed description has been presented for purposes of illustration and description. It is not intended to be exhaustive or limiting to the precise form disclosed. Many modifications and variations are possible in light of the above teachings. For example, common variations in structures and materials exist, and suitable modifications to accommodate such different structures and materials could readily be made. The described embodiments were chosen in order to best explain the principles of the disclosure and its practical application to thereby enable others skilled in the art to best utilize the disclosure in various embodiments and with various modifications as are suited to the particular use contemplated. It is intended that the scope of the invention be defined by the claims appended hereto.

1. A securing assembly for an exhaust system, comprising:
a securing structural element adapted to couple a first exhaust system part to a second exhaust system part; and
a button having a first surface configured to attach to an exterior surface of the first exhaust system part, the button engaging at least a portion of the securing structural element.

2. The securing assembly of claim 1 wherein the button has a generally rectangular shape having a length and a width, the first exhaust system part having an arcuate surface, the length oriented along the arcuate surface when attached thereto.

3. The securing assembly of claim 2 wherein the button has a plurality of raised energy directors.

4. The securing assembly of claim 3 wherein the height of the raised energy directors is in a range of about 0.007 inch to 0.03 inch.

5. The securing assembly of claim 4 wherein the length is a maximum of 1 inch for an exhaust system part has a diameter of two inches to 20 inches.

6. The securing assembly of claim 1 wherein the securing structural element comprises a securing ring having a hooked section engaging the second exhaust system part.

7. The securing assembly of claim 1 wherein the securing structural element comprises a retaining block having a recess engaging the button and a second end engaging the second exhaust system part.

8. The securing assembly of claim 1 wherein the button has a generally cylindrical shape having an upper portion and a lower portion.

9. The securing assembly of claim 6 wherein the button has a plurality of raised energy directors provided on a base of the lower portion.

10. The securing assembly of claim 1 wherein the button is secured to the first exhaust system part by a sonic weld.

11. A component for securing assembly for a non-metallic exhaust system, comprising:
a securing element having an upper portion having a width wider than a width of a lower portion, the lower portion having a bottom surface, the upper portion having a top surface including a recess; and
the bottom surface including a plurality of raised energy directors extending from the bottom surface to a height above the bottom surface.

12. The component of claim 11 wherein the upper portion and the lower portion have a generally rectangular shape, the upper portion defined by a first side, second side, third side and fourth side, and a top surface and a bottom surface, the first and second sides defining a length greater than a width defined by the third and fourth sides, the lower block defined by a fifth side, a sixth side, a seventh side and an eighth side, the fifth and sixth sides defining a length shorter than the length of the first and second side, the seventh and eight sides defining a width less than the width of the third and fourth sides, the bottom surface adjacent the lower block.

13. The component of claim 12 wherein the length of the first and second sides is less than one inch for an exhaust system component having a diameter of two inches to 20 inches.

14. The component of claim 12 wherein the recess has a rectangular shape and a base surface below the top surface.

15. The component of claim 12 wherein the height of the raised energy deflectors is in a range of about 0.007 inch to 0.03 inch.

16. The component of claim 11 wherein the upper portion and the lower portion have a generally cylindrical shape, each portion having a diameter.

17. The component of claim 16 wherein a height of the raised energy deflector above the bottom surface is in a range of about 0.007 inch to 0.03 inch.

18. The component of claim 16 wherein the upper portion has a diameter of less than or equal to about one (1) inch.

19. The component of claim 14 wherein the recess is cylindrical.
